(19) United States
(12) Patent Application Publication
(10) Pub. No.: US 2011/0207863 A1
(43) Pub. Date: Aug. 25, 2011

(54) COMPOSITE FILMS COMPRISING PASSIVATED NANOPARTICULATED CERAMIC OXIDES

(75) Inventors: Weijun Yin, Niskayuna, NY (US); Sergei Kniajanski, Clifton Park, NY (US); James Jun Xu, Niskayuna, NY (US); Patricia Chapman Irwin, Altamont, NY (US)

(73) Assignee: GENERAL ELECTRIC COMPANY, Schenectady, NY (US)

(21) Appl. No.: 12/709,560

(22) Filed: Feb. 22, 2010

(51) Int. Cl. C08K 5/5419

(52) U.S. Cl. 524/262

(57) ABSTRACT

The present invention is directed to high temperature performance filled polyimide materials useful for high power density applications having good ultra high thermal properties. A high temperature dielectric film is disclosed comprising an aromatic polyimide formed by a solution polycondensation reaction and a passivated nanoparticulate ceramic oxide dispersed within the aromatic polyimide. The ceramic oxide nanoparticles are comprised of a monofunctional organosilane covalently attached to the surface of the ceramic oxide nanoparticles.

### BACKGROUND

High power density avionic applications, such as motors, generators, transformers, and other power converters often use dielectric coatings, films, or layers to isolate power devices from short circuit-induced breakdown under electric stresses at high temperature environments. Thin films with high thermal endurance are of particular interest and usefulness.

Service longevity of power devices or electrical rotating machines under thermal and electrical stresses is of chief concern among original equipment manufacturers owning to costly installments, repairs, rewinding and replacement. Temperature (thermal) index (TI) or relative thermal index (RTI) of dielectric materials is such a valuable measure of their thermal capability upon which their thermal endurance capability can be evaluated and their thermal class can be assigned. It is thus a critical-to-quality to end-users. Numerous high thermal endurance polymers, including polyimides, are widely used as dielectric coatings and films and typically have a thermal index of equal to or less than 240° C. Fillers have been added to these temperature-resistance polymers wherein the filler imparts additional thermal or corona resistance properties. However, mechanical properties can be impaired as the fillers can be difficult, if not impractical to efficiently and economically disperse into such polymers, due to filler agglomeration.

Therefore what is needed is a filled dielectric coating, film, or layer with improved in heat and corona resistances that have sufficient mechanical properties for thin film applications. Further, an improvement in temperature capability may allow high power density applications to be made with a much smaller size and weight thus enhancing power density dramatically. The advantage may have applications in avionic military, geothermal and oil/gas down hole drill applications.

### BRIEF DESCRIPTION

The present invention is directed to high temperature filled polyimide films useful for high power density applications having good thermal propertiesand corona resistance at least ten times greater than that of an unfilled dielectric film having the same polymeric composition.

According to one embodiment of the invention, a high temperature film is disclosed comprising an aromatic polyimide formed by a solution polycondensation reaction and a passivated nanoparticulate ceramic oxide dispersed within the aromatic polyimide. The ceramic oxide nanoparticles are comprised of a monofunctional organosilane covalently attached to the surface of the ceramic oxide nanoparticles.

In one embodiment of the invention the monofunctional organosilane is an alkoxysilane of Formula I

RₓSi(OR′)_{y} I

wherein R can be identical or different and denotes an aryl or substituted aryl group having 5 to 19 aromatic carbon atoms, or substituted alkyl group having 1 to 20 carbon atoms, R′ can be identical or different and denotes an alkyl group having 1 to 8 carbon atoms, x is an integer from 1 to 3, and y is and integer equal to 4−x.

### DRAWINGS

These and other features, aspects, and advantages of the present invention will become better understood when the following detailed description is read with reference to the accompanying drawings in which like characters represent like parts throughout the drawings.

FIG. 1 is a representative micrograph of two films containing passivated 6% Al₂O₃ filler: (A) 6% Al₂O₃/ML, (B) 6% Al₂O₃/UBE.

### DETAILED DESCRIPTION

In the following specification and the claims, which follow, reference will be made to a number of terms, which shall be defined to have the following meanings.

The singular forms “a”, “an” and “the” include plural referents unless the context clearly dictates otherwise.

In the context of the present invention, alkyl is intended to include linear, branched, or cyclic hydrocarbon structures and combinations thereof. Lower alkyl refers to alkyl groups of from 1 to 6 carbon atoms, preferably from 1 to 4 carbon atoms, and includes methyl, ethyl, n-propyl, isopropyl, and n-, s- and t-butyl. Higher alkyl refers to alkyl groups having seven or more carbon atoms, preferably 7-20 carbon atoms, and includes n-, s- and t-heptyl, octyl, and dodecyl. Cycloalkyl is a subset of alkyl and includes cyclic hydrocarbon groups of from 3 to 8 carbon atoms. Examples of cycloalkyl groups include cyclopropyl, cyclobutyl, cyclopentyl, and norbornyl.

Aryl and heteroaryl mean a 5- or 6-membered aromatic or heteroaromatic ring containing 0-3 heteroatoms selected from nitrogen, oxygen or sulfur; a bicyclic 9- or 10-membered aromatic or heteroaromatic ring system containing 0-3 heteroatoms selected from nitrogen, oxygen or sulfur; or a tricyclic 13- or 14-membered aromatic or heteroaromatic ring system containing 0 to 3 heteroatoms selected from nitrogen, oxygen or sulfur. The aromatic 6- to 14-membered carbocyclic rings include, for example, benzene, naphthalene, indane, tetralin, and fluorene; and the 5- to 10-membered aromatic heterocyclic rings include, e.g., imidazole, pyridine, indole, thiophene, benzopyranone, thiazole, furan, benzimidazole, quinoline, isoquinoline, quinoxaline, pyrimidine, pyrazine, tetrazole and pyrazole.

Arylalkyl means an alkyl residue attached to an aryl ring. Examples are benzyl and phenethyl. Heteroarylalkyl means an alkyl residue attached to a heteroaryl ring. Examples include pyridinylmethyl and pyrimidinylethyl. Alkylaryl means an aryl residue having one or more alkyl groups attached thereto. Examples are tolyl and mesityl.

Alkoxy or alkoxyl refers to groups of from 1 to 8 carbon atoms of a straight, branched, cyclic configuration and combinations thereof attached to the parent structure through an oxygen atom. Examples include methoxy, ethoxy, propoxy, isopropoxy, cyclopropyloxy, cyclohexyloxy, and phenoxy. Lower alkoxy refers to groups containing one to four carbons.

Substituted refers to residues, including, but not limited to, alkyl, alkylaryl, aryl, arylalkyl, and heteroaryl, wherein up to three H atoms of the residue are replaced with lower alkyl, substituted alkyl, alkenyl, substituted alkenyl, aryl, substituted aryl, haloalkyl, alkoxy, carbonyl, carboxy, carboxalkoxy, carboxamido, acyloxy, amidino, nitro, halo, hydroxy, OCH(COOH)₂, cyano, primary amino, secondary amino, acylamino, alkylthio, sulfoxide, sulfone, phenyl, benzyl, phenoxy, benzyloxy, heteroaryl, or heteroaryloxy.

Haloalkyl refers to an alkyl residue, wherein halogen atoms replace one or more H atoms; the term haloalkyl includes perhaloalkyl. Examples of haloalkyl groups that fall within the scope of the invention include CH₂F, CHF₂, and CF₃.

Many of the compounds described herein may contain one or more asymmetric centers and may thus give rise to enantiomers, diastereomers, and other stereoisomeric forms that may be defined, in terms of absolute stereochemistry, as (R)— or (S)—. The present invention is meant to include all such possible isomers, as well as, their racemic and optically pure forms. Optically active (R)— and (S)— isomers may be prepared using chiral synthons or chiral reagents, or resolved using conventional techniques. When the compounds described herein contain olefinic double bonds or other centers of geometric asymmetry, and unless specified otherwise, it is intended that the compounds include both E and Z geometric isomers. Likewise, all tautomeric forms are also intended to be included.

“Optional” or “optionally” means that the subsequently described event or circumstance may or may not occur, and that the description includes instances where the event occurs and instances where it does not.

As used herein, the term “solvent” can refer to a single solvent or a mixture of solvents.

“Surface passivation” refers to a method of reducing the reactivity of a chemically active ceramic oxide surface. Passivation may be accomplished by a surface coating or treatment with a passivating agent, which reacts with active sites on the ceramic oxide surface rendering those sites inactive.

Approximating language, as used herein throughout the specification and claims, may be applied to modify any quantitative representation that could permissibly vary without resulting in a change in the basic function to which it is related. Accordingly, a value modified by a term or terms, such as “about”, is not to be limited to the precise value specified. In some instances, the approximating language may correspond to the precision of an instrument for measuring the value.

This invention relates to high temperature compositions comprising an imide-containing polymer and a passivated nanoparticulate ceramic oxide dispersed within the polymer to increase the thermal performance of the composition.

While ceramic oxides have been used previously as filler in polyimides, generally the ceramic oxide is surface treated with a bi-functional coating that acts as a coupling agent between the ceramic oxide and the polymer matrix. For example functionalized organosilane coupling agent, are used wherein the siloxane group forms a silanolate bond with the ceramic oxide and the functional group is selected to react with the functionality on the polymer. In these instances, the silane-coupling agent may be an epoxy group or an amino group. Typical functional groups may include gamma-glycidoxyproplytrimethoxysilane and N-(beta-(aminoethyl)gamma-aminopropyltimethoxy silane.

In the present invention, a monofunctional organosilane is used to passivate the ceramic oxide nanoparticles and not a bi-functional coupling agent. As used herein the term monofunctional organosilane refers to an organosilane having only one type of reactive group capable of binding to a system component. Similarly, a bifunctional organosilane denotes an organosilane having two types of reactive groups where each of them is capable of reacting with two different components.

As such the organosilane is designed to fully react with the ceramic oxide through a single type of reactive species on the organosilane and to be unreactive towards the polyimide. The reaction between the organosilane and the ceramic oxide results in covalent attachment of the organosilane to the ceramic oxide and surface passivation of the ceramic oxide. The chemical reactivity between the passivated ceramic oxide and the imide-containing polymer is diminished. The organosilane does not function as a coupling agent between the ceramic oxide and the polymer matrix.

The passivated organosilane coated ceramic oxide nanoparticle may then be readily incorporated into the imide-containing polymer with efficient dispersion to increase thermal properties without diminishing desired physical properties. The mode of dispersion may include, but is not limited to mixing, stirring, shaking, and sonication.

In certain embodiments, the monofunctional organosilane is an alkoxysilane of Formula I

RₓSi(OR′)_{y} I

wherein R can be identical or different and denotes an aryl or substituted aryl group having 5 to 19 aromatic carbon atoms, or substituted alkyl group having 1 to 20 carbon atoms;

R′ can be identical or different and denotes an alkyl group having 1 to 8 carbon atoms;

x is from 1 to 3; and

y is equal to 4-x.

In certain embodiments R may be phenyl, o-alkylphenyl, m-alkylphenyl, p-alkylphenyl, halophenyl, nitrophenyl, chloro alkylphenyl, alkoxyphenyl or combinations thereof. In other embodiments, R is alkyl substituted with halo, cyano, amido, imido, nitro, isocyanate, alkoxy, or combinations thereof.

R′ may be a lower alkyl group such as methyl, ethyl, n-propyl, isopropyl, n-butyl, s-butyl, t-butyl, or combinations thereof. In certain embodiments, the alkoxysilane is phenyl-trimethoxy silane.

R′ groups may be selected in a way that optimizes the interaction of the organosilane with the ceramic oxide nanoparticle to maximize coating efficiency and coverage. Selection of R may further impart certain polarity and miscibility with a polyimide, but does not provide chemical reactivity with the polyimide or with other system components.

The ceramic oxide nanoparticles are selected primarily to provide enhanced properties to the polyimide polymer matrix. As such, particle size distribution, impurity levels, degree of hydration, and crystallinity of the nanoparticles are factors to be controlled.

In certain embodiments, the ceramic oxide nanoparticles may be comprised of silica, alumina, titania (titanium oxide), zirconia (zirconium oxide), and combinations thereof. In a particular embodiment the ceramic oxide nanoparticles may be alumina.

In certain embodiments the ceramic oxide nanoparticles provided by the present invention are characterized by a mean particle size from 5 to about 150 nanometers. In one embodiment, the ceramic oxide nanoparticles provided by the present invention are characterized by a mean particle size from about 20 to about 100 nanometers. While various particle size ranges may be used, larger particle size may impact the flexibility of the film.

In one embodiment, the passivated nanoparticulate ceramic oxide provided by the present invention are prepared by (a) suspending ceramic oxide nanoparticles in an organic or an aqueous organic solution with an alkoxysilane of Formula I, (b) optionally sonicating the suspension with at least one of subsonic forces or sonic forces, (c) heating the suspension to about 80° C. to 120° C. for about 1 to 6 hrs, (d) isolating the resultant passivated nanoparticulate ceramic oxide from the solvent, and (e) suspending passivated nanoparticulate ceramic oxide in another solvent.

Selection of the solvent to suspend the passivated nanoparticulate ceramic oxide is such that it dissolves the aromatic polyimide precursor while allowing for adequate suspension of the passivated nanoparticulate ceramic oxide. In certain embodiments the solvent used may be the same as used in the polyimide precursor solution. Examples of typical solvents include anhydrous dimethlyacetamide and N-methylpyrrolidone.

The organosilane is present in an amount sufficient to passivate the ceramic oxide nanoparticles and to diminish reaction between the nanoparticles and the imide-containing polymer. The amount of alkoxysilane in the passivation reaction is such that to coat essentially all surfaces of the nanoparticulate ceramic oxide, and is calculated based on the ceramic oxide particle size, the density of the hydroxyl groups on the nanoparticulate surface, and alkoxysilane molecular weight. As such, the passivated nanoparticulate ceramic oxide isolated from the organic solvent may have organosilane present in an amount that may vary from 0.5 to 85 weight percent.

Polyimides are defined as polymers incorporating the imide group in their repeating unit as an open chain or as a closed ring. In general, polyimides most often used in high temperature applications, and therefore of particular use in the present invention, are those wherein the imide is a closed ring such as aromatic polyimides. Aromatic polyimides are able to retain high strength under continuous use at temperatures up to about 300° C. and even higher for brief periods of time.

In certain embodiments, aromatic polymides are used that are formed by solution polycondensation reactions of aromatic polyimide precursors in a solvent system comprised of highly polar solvents. The highly polar solvents include, but are not limited to N,N-dimethylacetamide (DMA), dimethylformamide (DMF), dimethylsulfoxide (DMSO), N-methyl-2-pyrolidone (NMP), and combination thereof. The polyimide aromatic precursors may include a diamine, dianydride, diacid, diisocyanate, or a dihalogen having at least one aromatic ring, either alone (i.e., a substituted or unsubstituted, functionalized or unfunctionalized benzene or similar-type aromatic ring) or connected to another (aromatic or aliphatic) ring. The aromatic dianhydride precursor may include, for example, pyromellitic dianhydride, 4,4′-oxydiphthalic anhydride, 2,2-bis(3,4-dicarboxyphenyl) hexafluoropropanedianhydride) tetracarboxylic dianhydrides, e.g., benzophenonetetracarboxylic dianhydride, isopropylidenebis(benzene-3,4-dicarboxylic) dianhydride, or 3,3′,4,4′-diphenyltetracarboxylic dianhydride. The aromatic diamine precursor may include, for example, 4,4′-methylenebisdianiline, 4,4′-oxydianiline, p-phenylenediamine, chloro-p-phenylenediamine, m-phenylenediamine; and 4,4′-sulfonedianiline. In each case, the aromatic polyimide thus formed has a Tg of 300° C. or greater based on DMA testing.

In certain embodiments, the aromatic polyimide precursors are commercially available. Examples of commercially available polyimide precursors are U-Varnish-A and U-Varnish-S from UBE Industries (Tokyo, Japan) or Pyre-ML® solutions from Industrial Summit Technology (Shiga, Japan). In certain other embodiments the aromatic polyimide precursors may be fluorinated polyimide precursors such as those containing a —C(CF₃)₂— linkage.

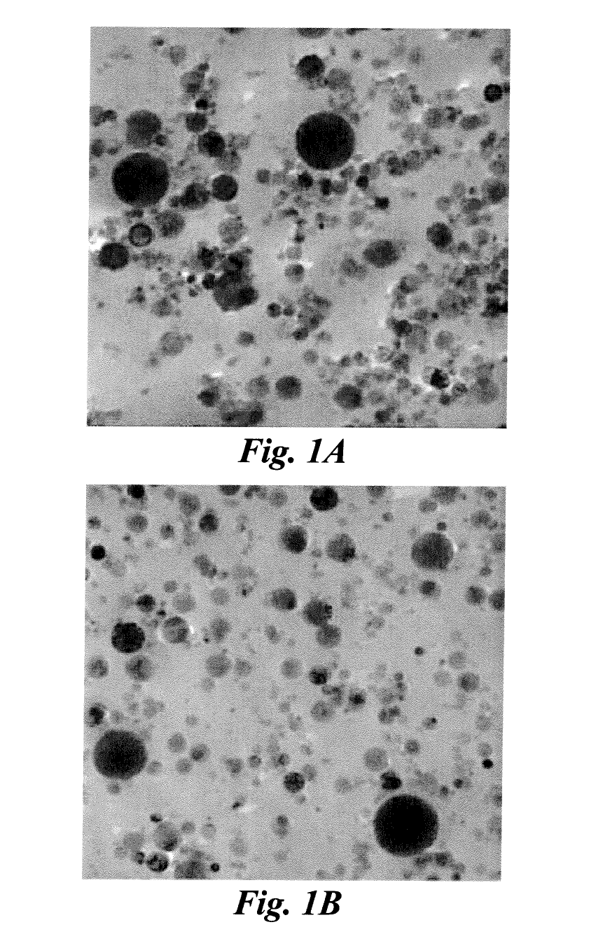

The present invention provides for compositions comprising an aromatic polyimide polymer matrix and a passivated nanoparticulate ceramic oxide, dispersed within the polymer matrix. Thus in one embodiment, the passivated nanoparticulate ceramic oxide is dispersed within the aromatic polyimide polymer matrix such that the agglomeration of the particles is reduced compared to the non-passivated filler. This is shown in FIGS. 1A and B which are micrographs of two films containing passivated 6% Al₂O₃ filler: (A) 6% Al₂O₃/ML, (B) 6% Al₂O₃/UBE. Corresponding films made with non-passivated filler resulted in brittle films with poor integrity.

Those methods suitable for the incorporation of the passivated nanoparticulate ceramic oxide within the polyimide polymer matrix may be applied to the preparation of dielectric films and coatings. The composition can be used in a variety of forms as a film or coating material. One of ordinary skill in the art will recognize that the film or coating may be formed using a variety of conventional techniques including casting, dip coating, spin coating, spray coating, and nozzle coating. The coating may be applied in a continuous or discontinuous technique to allow for intermediate layers to be formed and thereby increasing film thickness. Intermediate curing of the film and solvent removal may also be required. Film thickness may vary. Useful film thickness may be from about 2 to about 50 microns. In some embodiments, the film thickness is from about 10 microns to about 30 microns. In another embodiment, the film thickness is from about 15 to about 20 microns.

The composition may also include other additives. These may include, but are not limited to, additives such as stabilizers, lubricants, dispersion agents, processing aids, or other additives commonly used in film and coating composition.

### EXAMPLES

Dielectric films were formed by addition of 5% of passivated nanoparticulate alumina to Pyre-ML or U-V-S. The films were directly compared to unfilled polyimide films. The films made with non-passivated alumina show poorer mechanical properties and activation energies were not tested using thermogravimetric analysis (TGA). The temperature index (TI) at 20,000 hrs, and relative temperature index (RTI) at 60,000 hrs was determined by TGA methods according to ASTM E1641 and ASTM E1877 testing protocols. The results are shown in Table I and are based on 5% weight loss as end-test criterion of the formed films. It is known to those skilled in the art that the retention of 90%-95% weights of a dielectric material may be correlated to approximately 50% retention of functional properties such as mechanical strengths and dielectrical breakdown strengths:

TABLE 1
Thermal Index determined by TGA methods

| | | | | | RTI, relative |
|---|---|---|---|---|---|
| | End-point criteria: | T, Temp @ | Act Energy | TI, \hat{ }temperature | temperature index, |
| Insulations | 5 wt % | 5 wt % loss, Deg C. | (kJ/mol) | Index, 20,000 hrs | 60,000 hrs |
| ML control film | 95.00% | 492.3 | 146.1 | 240 | 224 |
| Composite-ML-Al₂O₃ film | 95.00% | 544.4 | 157.1 | 262 | 246 |
| UBE film | 95.00% | 559.8 | 158.2 | 286 | 269 |
| Composite-UBE-Al₂O₃ film | 95.00% | 569.3 | 192.6 | 307 | 291 |

The results clearly indicate that the passivated alumina increases the temperature index of the respected filled polyimide film by 20° C. or more. By correctly selecting a polyimide precursor, such as biphenylenetracarboxylic acid dianhydride and p-phenylene diamine, the resulting alumina nanocompo site film may reach thermal index greater than 300° C.

The thermal capability of the polymers was estimated from the thermogravimetric analysis (TGA). Thermal behavior data are listed in Table 2 and represent the average value of two film samples. The higher the decomposition temperature of the film is, the higher the thermal stability it has. Similarly, the higher the residual weight, the better the thermal stability of the film. The thermal stability increases with the concentration level of alumina.

TABLE 2
Thermal Behavior

| | Temp., ° C. @ | Temp., ° C. @ | Ramp rate, |
|---|---|---|---|
| Sample | 5% weight loss | 10% weight loss | ° C./min. |
| 6% Al2O3 | 585.11 | 612.64 | 10 |
| (45 nm) - UBE | | | |
| | 569.28 | 596.53 | 5 |
| | 540.65 | 568.91 | 2 |
| 6% Al2O3 | 564.19 | 590.54 | 10 |
| (45 nm) - ML | | | |
| | 544.36 | 571.63 | 5 |
| | 513.01 | 539.48 | 2 |

The inorganic component of the filler may improve corona resistance as well as thermal resistance. In certain embodiments, corona resistance is improved as measured by pulse surge endurance. As shown in Table 3, a ML control sample was compared to a ML 4% Al₂O₃ nanocomposition. The average film thickness of the samples was 15 microns and 17 microns respectively. A pulse generator (DEI PVX-4140) supplied a 1.25 kV, 20 kHx square waveform pulse with a 30 ns rise time to six film samples of each composition. Time to failure was measured and in each case, the nanocomposition showed at least a 10-fold improvement as compared to its corresponding unfilled film version.

TABLE 3
Pulse Surge Endurance Test

| Sample | | |
|---|---|---|
| Number | ML control sample | ML 4% Al2O3 nanocomposite |
| 1 | 6 min. | >3 hrs (stopped prior to failure) |
| 2 | 7 min. 30 sec | 2 hr 7 min. 23 sec |
| 3 | 6 min. 30 sec | 2 hr 53 min. 18 sec |
| 4 | 7 min. 43 sec | >3 hrs (stopped prior to failure) |
| 5 | 7 min. 25 sec | 2 hrs 19 min. 20 sec |
| 6 | 6 min 54 sec | 2 hrs. 44 min. 05 sec |

The invention may be embodied in other specific forms without departing from the spirit or essential characteristics thereof. The foregoing embodiments are therefore to be considered in all respects as illustrative rather than limiting on the invention described herein. The scope of the invention is thus indicated by the appended claims rather than by the foregoing description, and all changes that come within the meaning and range of equivalency of the claims are therefore intended to be embraced therein.

Step 1. Alumina Surface Treatment Alumina (20 g of 45 nm mean particle size available as NanoArc® Aluminum oxide from Nanophase Technologies (Romeoville, Ill.) or Premalox® OceanState Abrasions (West Warwick, R.I.)) was suspended in 200 ml of anhydrous toluene and 40 ml of anhydrous isopropanol. Phenyltrimethoxysilane (3 ml) was added, and the suspension was sonicated with horn sonicator for 10 min using “20 sec on—4 sec off” profile at 66 W output. The flask with suspension was immersed into ice bath during the sonication. The resulted suspension was refluxed for 3 hours and was then allowed to cool to room temperature. The resulted suspension did not sediment for hours. It was filtered through 10 micron sintered glass. The filtration funnel was capped with a rubber diaphragm to prevent moisture access to the material. The product was finally dried in a vacuum oven for 6 hrs at 80° C.

### Step 2. Stable Alumina Solution

Alumina (4 g from step 1) was added to a glass vial containing 40 ml of NMP solution. The vial was tightly closed and left in a sonica water bath (42 kHz and 155 W) for sonication for 3 to 5 hrs. A homogenous stable milky solution is formed.

### Step 3. Alumina and Polyimide Composite Film Preparation

Control samples of Pyre_mL solution (Industrial Summit Technology) or UBE-V-S solution (UBE America) were prepared using standard cast solution methods.

2% phr 45 nm treated Al₂O₃/ML: 6 g of alumina solution with 9% solids by weight (prepared as described in step 2) and average particle size of 45 nm was added to a glass vial immersed in a an ice bath and sonicated with a horn sonicator for 15 min using (10 sec on—5 sec off) pulsing profile at 66 W output while stirring with a magnetic stir bar. 30 g of Pyre-ML RC-5019 solution (purchased from Sigma Aldrich) with 10% solids by weight was added and sonicated for an additional 15 min using the same pulsing profile. The solution was warmed to 80° C., degassed and cast on to a glass substrate with a film caster set at 10 mils under temperature of 80° C.

4% phr 45 nm treated Al₂O₃/ML: 12 g of alumina solution with 9% solids by weight and average particle size of 45 nm was dispersed into a 30 g of Pyre-ML RC-5019 solution with 10% solids by weight using the same procedure and casting process as indicated above.

6% phr 45 nm treated Al₂O₃/ML: 18 g of alumina solution with 9% solids by weight and average particle size of 45 nm was dispersed into a 30 g of Pyre-ML RC-5019 solution with 10% solids by weight using the same procedure and casting process as indicated above

4% phr 150 nm treated Al₂O₃/ML: 12 g of alumina solution with 9% solids by weight and average particles of 150 nm was dispersed in 30 g of 30 g of Pyre-ML RC-5019 solution with 10% solids by weight using the same procedure and casting process as indicated above 2% 45 nm treated Al₂O₃/UBE: 6 g of alumina solution with 9% solids by weight (prepared as step 2 was added to a glass vial immersed in an ice bath, and sonicated with a horn sonicator for 15 min using (10 sec on—5 sec off) pulsing profile at 66 W output while stirring with a magnetic stir bar. 30 g of UBE-V-S solution (purchased from UBE America) with 10% solids by weight was added and the solution was sonicated for an additional 15 min using the same pulsing profile. The solution was warmed to 80° C., degassed and cast on a glass substrate with a film caster set at 10 mils under temperature of 80° C.

4% 45 nm treated Al₂O₃/UBE: 12 g of alumina solution with 9% solids by weight and average particle size of 45 nm was dispersed into a 30 g of UBE-V-S solution with 10% solids by weight using the same procedure and casting process as indicated above.

6% 45 nm treated Al₂O₃/UBE: 18 g of alumina solution with 9% solids by weight and average particle size of 45 nm was dispersed into a 30 g of UBE-V-S solution with 10% solids by weight using the same procedure and casting process as indicated above.

4% 150 nm treated Al₂O₃/UBE: 12 g of alumina solution with 9% solids by weight and average particle size of 150 nm was dispersed into a 30 g of UBE-V-S solution with 10% solids by weight using the same procedure and casting process as indicated above.

Cure Cycle for PI films

The casted film was peeled off the glass substrate and mounted on to a metal frame. The films were placed into a vacuum oven. The film made with ML solution was exposed to the following heat cycle for complete imidization: 120° C. for 1 hr, 165° C. for 2 hrs, 200° C. for 2 hrs, and then 250° C. for 1 hr. The film made with UBE-V-S solution was cured with the heating profile as follows: 120° C. for 1 hr, 165° C. for 2 hrs, 200° C. for 2 hrs, 250° C. for 1 hr, and then 2800° C. for 30 min. to 1 hour. Films were cooled slowly to room temperature before removal.

1. A composite dielectric film having a corona resistance at least ten times greater than that of an unfilled dielectric film having the same polymeric composition wherein said dielectric film comprises:
an aromatic polyimide formed by a solution polycondensation reaction;
a passivated nanoparticulate ceramic oxide comprising;
ceramic oxide nanoparticles; and
a monofunctional organosilane covalently attached to said ceramic oxide nanoparticles; and
wherein said passivated nanoparticulate ceramic oxide is dispersed within said aromatic polyimide.

2. The film of claim 1 wherein the monofucntional organosilane is an alkoxysilane of Formula I
RₓSi(OR′)_{y} I
wherein R can be identical or different and denotes an aryl or substituted aryl group having 5 to 19 aromatic carbon atoms, or substituted alkyl group having 1 to 20 carbon atoms;
R′ can be identical or different and denotes an alkyl group having 1 to 8 carbon atoms;
x is an integer from 1 to 3; and
y is an integer equal to 4−x.

3. The film of claim 2 wherein R is phenyl, o-alkylphenyl, m-alkylphenyl, p-alkylphenyl or combinations thereof.

4. The film of claim 2 wherein R′ is methyl, ethyl, n-propyl, isopropyl, n-butyl, s-butyl, t-butyl, or combinations thereof.

5. The film of claim 2 wherein the alkoxysilane is phenyltrimethoxysilane.

6. The film of claim 5 wherein the ceramic oxide nanoparticles is alumina.

7. The film of claim 1 wherein the aromatic polyimide has a polymer matrix glass transition temperature (Tg) of 300° C. or greater based on dynamic mechanical analysis (DMA).

8. The film of claim 7 wherein the polyimide is formed from a polyimide aromatic precursor comprising pyromellitic dianhydride, tetracarboxylic dianhydride, 4,4′-methylenebisdianiline, 4,4′-oxydianiline, p-phenylenediamine, chloro-p-phenylenediamine, m-phenylenediamine, 4,4′-sulfonedianiline, and combinations thereof.

9. The film of claim 7 wherein the polyimide is formed from a fluorinated polyimide aromatic precursor.

10. The film of claim 1 wherein the film is formed by casting, dip coating, spin coating, spray coating, or nozzle coating.

11. The dielectric film of claim 1 wherein the passivated nanoparticulate ceramic oxide have an average particle size of between 20 nm and 100 nm.
